(19) United States
(12) Patent Application Publication
(10) Pub. No.: US 2019/0348203 A1
(43) Pub. Date: Nov. 14, 2019

(54) COMBINED COIL MODULE AND MAGNETIC SHEET

(71) Applicant: Panasonic Intellectual Property Management Co., Ltd., Osaka (JP)

(72) Inventors: KATSUTOSHI HIRAKAWA, Osaka (JP); KOUICHI NAKAMURA, Miyazaki (JP); KOUJI YASUMURA, Miyazaki (JP)

(21) Appl. No.: 16/461,416

(22) PCT Filed: Nov. 7, 2017
(86) PCT No.: PCT/JP2017/040028

§ 371 Date: May 16, 2019

(30) Foreign Application Priority Data
Nov. 29, 2016 (JP) 2016-231029
Nov. 29, 2016 (JP) 2016-231034

(51) Int. Cl. H01F 1/375; H01F 38/14; H02J 5/00; H04B 5/00; H02J 50/10; B32B 27/08; B32B 25/08; B32B 25/20

(52) U.S. Cl. CPC H01F 1/375; H01F 38/14; H02J 5/005; H04B 5/0037; B32B 2264/10; B32B 27/08; B32B 25/08; B32B 25/20; H02J 50/10

(57) ABSTRACT

A combined coil module includes a first planar coil, a second planar coil, and a magnetic sheet in which a magnetic path of the first planar coil and a magnetic path of the second planar coil are to be formed. The first planar coil is used for radio communication. The second planar coil is used for electric power transmission of contactless charging. The magnetic sheet is made of one kind of a magnetic material. The magnetic sheet includes a first magnetic path formation portion in which the magnetic path of the first planar coil is to be formed and a second magnetic path formation portion in which the magnetic path of the second planar coil is to be formed. A permeability of the first magnetic path formation portion is different from a permeability of the second magnetic path formation portion.

### TECHNICAL FIELD

The present disclosure relates to a combined coil module used for an antenna module, a contactless charging module, and the like in which Qi defined by Near Field Communication (NFC) or Wireless Power Consortium (WPC) or wireless feeding of Power Matters Alliance (PMA) and Alliance for Wireless Power (A4WP) is incorporated, The present disclosure also relates to a new magnetic sheet including a portion having different permeability that is suitably used for the combined coil module and the like.

### BACKGROUND

Radio Frequency IDentification (RFID) supporting a ubiquitous society is in practical use in various fields, and RFID is incorporated in a mobile terminal having a contactless IC card function as an example. For example, a 13.56-MHz-band RFID system (radio communication using an IC tag and an IC card) including a spiral antenna is widely used as an electronic money card used in a convenience store, a super market, and public transportation while an IC chip is incorporated in a thin resin card. Currently, a move to incorporate an NFC of the 13.56-MHz band in the mobile terminal accelerates.

In the NFC of the 13.56-MHz band, electric power supply and communication are performed by electromagnetic induction generated between the spiral antennas included in both a reader and writer device and the mobile terminal.

Recently, it is proposed to incorporate not only the NFC but also the contactless charging module in the mobile terminal so as to charge the mobile terminal by contactless charging. In this technique, a transmission coil is disposed on a charger side, and a reception coil is disposed on a mobile terminal side. And the electromagnetic induction is generated between both the coils at a frequency of a 100-kHz band to charge the mobile terminal.

The NFC is near field radio communication in which communication is conducted by the electromagnetic induction using the frequency of the 13.56-MHz band, and the electric power transmission is performed by the electromagnetic induction of the coil using the frequency of the 100-kHz band in the contactless charging. In the case that an antenna and a contactless charging coil of the NFC are constructed in the same module, the following means are proposed (for example, see PTL 1). Since a resonance frequency of the 13.56-MHz band of the NFC antenna is different from a resonance frequency of the 100-kHz band of the contactless charging coil, both communication efficiency of the NFC and electric power transmission efficiency of the contactless charging are improved by laminating two kinds of magnetic materials having different characteristics.

### CITATION LIST

### Patent Literature

PTL 1: Unexamined Japanese Patent Publication No. 2013-121248

### SUMMARY

According to one aspect of the present disclosure, a combined coil module includes a first planar coil, a second planar coil, and a magnetic sheet in which a magnetic path of the first planar coil and a magnetic path of the second planar coil are to be formed. The first planar coil is used for radio communication. The second planar coil is used for electric power transmission of contactless charging. The magnetic sheet is made of one kind of a magnetic material. The magnetic sheet includes a first magnetic path formation portion in which the magnetic path of the first planar coil is to be formed and a second magnetic path formation portion in which the magnetic path of the second planar coil is to be formed. A permeability of the first magnetic path formation portion is different from a permeability of the second magnetic path formation portion.

According to another aspect of the present disclosure, a magnetic sheet is made of one kind of a magnetic material. The magnetic sheet includes: a first portion having a first permeability; and a second portion having a second permeability. The second permeability is different from the first permeability.

In the present disclosure, modularization of the radio communication coil and the contactless charging coil using the magnetic sheet made of the one kind of the magnetic material can provide miniaturization of the combined coil module and simplification of a manufacturing process. And thus cost reduction of the combined coil module can be achieved. Further both the communication efficiency of the radio communication and the electric power transmission efficiency of the contactless charging can be improved in the magnetic sheet made of the one kind of the magnetic material.

### BRIEF DESCRIPTION OF DRAWINGS

FIG. 1A is a schematic sectional view (a schematic sectional view taken along a line 1A-1A in FIG. 1B) illustrating an example of a combined coil module according to an exemplary embodiment.

FIG. 1B is a schematic plan view illustrating an example of the combined coil module.

FIG. 2A is a schematic plan view illustrating an example of a magnetic sheet used in the combined coil module of the exemplary embodiment.

FIG. 2B is a schematic sectional view illustrating an example of the magnetic sheet used in the combined coil module.

FIG. 3 is a schematic plan view illustrating an example of a first magnetic path formation portion and a second magnetic path formation portion of the magnetic sheet used in the combined coil module of the exemplary embodiment.

FIG. 4A is a schematic sectional view illustrating an example of a slit shape provided in the magnetic sheet used in the combined coil module of the exemplary embodiment.

FIG. 4B is a schematic sectional view illustrating an example of the slit shape provided in the magnetic sheet used in the combined coil module of the exemplary embodiment.

FIG. 5 is a schematic plan view illustrating another example of the first magnetic path formation portion and the second magnetic path formation portion of the magnetic sheet used in the combined coil module of the exemplary embodiment.

FIG. 6 is a schematic plan view illustrating still another example of the first magnetic path formation portion and the second magnetic path formation portion of the magnetic sheet used in the combined coil module of the exemplary embodiment.

FIG. 7 is a schematic sectional view illustrating yet another example of the first magnetic path formation portion and the second magnetic path formation portion of the magnetic sheet used in the combined coil module of the exemplary embodiment.

FIG. 8 is a flowchart illustrating an example of a magnetic sheet manufacturing process of the exemplary embodiment.

FIG. 9 is a graph showing a frequency characteristic of permeability (μ′, μ″) in a conventional Mn—Zn ferrite sheet (magnetic sheet).

FIG. 10 is a graph showing a relationship between a slit pitch and the permeability of the magnetic sheet of the exemplary embodiment.

FIG. 11 is a graph showing the frequency characteristic of a Mn—Zn ferrite sheet (magnetic sheet) of the exemplary embodiment.

### DESCRIPTION OF EMBODIMENT

Problems found in conventional techniques will briefly be described prior to the description of an exemplary embodiment of the present disclosure. In PTL 1, it is necessary to laminate the two kinds of the magnetic sheets having different characteristics in the antenna and the contactless charging coil of the NFC. For this reason, a process of preparing the combined coil module becomes complicated, and cost of the combined coil module is hardly reduced.

The present disclosure provides a combined coil module and a magnetic sheet in which the modularization and miniaturization of the radio communication coil and the contactless charging coil using the magnetic sheet made of the one kind of the magnetic material can simplify a combined coil module manufacturing process, and achieve cost reduction of the combined coil module. Hence, both the communication efficiency of the radio communication and the electric power transmission efficiency of the contactless charging in the magnetic sheet made of the one kind of the magnetic material can be improved.

A combined coil module according to an exemplary embodiment of the present disclosure will be described below with reference to the drawings.

A magnetic material, a protective layer, and an antenna module that are described below are only by way of example, and are not limited to the following configurations and materials.

A combined coil module of the exemplary embodiment will be described.

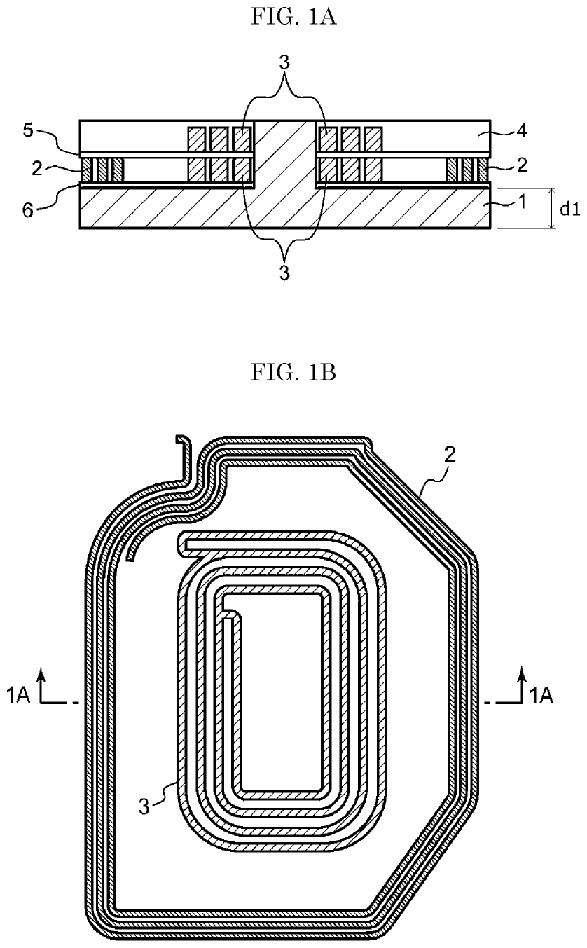

FIGS. 1A and 1B illustrate an example of the combined coil module of the exemplary embodiment. FIG. 1A is a schematic sectional view (a schematic sectional view taken along a line 1A-1A in FIG. 1B) illustrating an example of the combined coil module, and FIG. 1B is a schematic plan view illustrating an example of the combined coil module.

As illustrated in FIG. 1A, the combined coil module of the exemplary embodiment includes substrate 5 and magnetic sheet 1.

Substrate 5 includes at least one kind of wound first planar coil 2 used for near field radio communication and wound second planar coil 3 used for electric power transmission of contactless charging. Second planar coil 3 is used as a charging coil, and first planar coil 2 disposed so as to surround the charging coil is a near field radio communication antenna.

First planar coil 2 and second planar coil 3 that are formed on substrate 5 are bonded to magnetic sheet 1 with bonding layer 6 disposed between magnetic sheet 1 and substrate 5.

Substrate 5 can be formed by a flexible insulating film. Polyimide, polyethylene terephthalate (PET), a glass epoxy substrate, and a flexible printed board (FPC) can be cited as a specific example of the insulating film. When polyimide, PET, and the like are used as the substrate, which allows preparation of a thin, flexible antenna module. In the exemplary embodiment, for example, a polyimide film having a thickness ranging from 10 μm to 200 μm, inclusive, is preferably used.

For example, first planar coil 2 conducts the near field radio communication by electromagnetic induction in which a specific frequency band called RFID is used. For example, a 13.56-MHz frequency can be used for Near Field Communication (NFC). An NFC antenna is an antenna that conducts communication by electromagnetic induction using a frequency of a 13.56-MHz band, and a sheet antenna is typically used.

Second planar coil 3 is what is called a charging coil that performs electric power transmission such as contactless charging by electromagnetic induction in which a frequency of about 100 kHz to about 200 kHz is used according to a standard such as Wireless Power Consortium (WPC), Power Matters Alliance (PMA), and Alliance for Wireless Power (A4WP). For example, a copper foil having a line width of about 800 μm and a thickness of about 60 μm, which is formed through a plating process, is wound around a hollow portion so as to draw a spiral on a surface so that the charging coil is formed. Two terminals of the copper foil are used as a starting terminal and an ending terminal in the charging coil.

Usually first planar coil 2 and second planar coil 3 are wound.

So called “α winding” can be cited as a specific example of a method for winding the first planar coil and the second planar coil. However, the winding method is not limited to the a winding, but any shape such as a substantial rectangular shape, a substantial square shape, an elliptic shape, and a polygonal shape may be used. In FIG. 1A, each of winding numbers of the first planar coil and the second planar coil is three. However, the winding number is not limited to three. There is no particular limitation on a material, a height, and a width of a conductor constituting each of first planar coil 2 and second planar coil 3 and a gap between adjacent conductors. For example, a metal foil such as a copper foil can be used as the material of the conductor, and the height of the conductor, namely, the thicknesses of first planar coil 2 and second planar coil 3 may range from about 70 μm to about 80 μm, inclusive.

As described above, the single substrate includes both first planar coil 2 and second planar coil 3, so that multifunction and miniaturization can be implemented.

One of first planar coil 2 and second planar coil 3 is provided inside the other planar coil. At this point, although first planar coil 2 may be provided inside second planar coil 3, from the viewpoint of less communication disturbance, as illustrated in FIGS. 1A and 1B, preferably second planar coil 3 that performs contactless electric power transmission is provided inside, and first planar coil 2 that conducts near field radio communication is provided outside. For this reason, in the following combined coil module, a configuration of first planar coil 2 that is provided so as to surround second planar coil 3 will be described.

Two main surfaces of substrate 5 are set to a first surface and a second surface, respectively. A though-hole is made in substrate 5. Second planar coil 3 is provided on the first surface and the second surface of substrate 5 so as to surround the through-hole. Second planar coil 3 is electrically connected by a plating through-hole. Protective layer 4 is preferably provided on both the first surface and the second surface of the substrate in order to protect the second planar coil. A cured product of liquid solder resist, solder resist film, and a cover ray can be cited as a specific example of the protective layer. Protective layer 4 is not necessarily provided. Second planar coil 3 may be provided on both the first surface and the second surface of substrate 5 (double-layer structure), or provided in one of the first surface and the second surface of the substrate (single-layer structure). First planar coil 2 is provided in the second surface of the substrate so as to surround second planar coil 3. There is a possibility that radio interference is generated when first planar coil 2 is provided on both the surfaces of the substrate, so that preferably first planar coil 2 is provided on the single surface of substrate 5. In the combined coil module of FIG. 1A, first planar coil 2 is provided on the second surface of substrate 5.

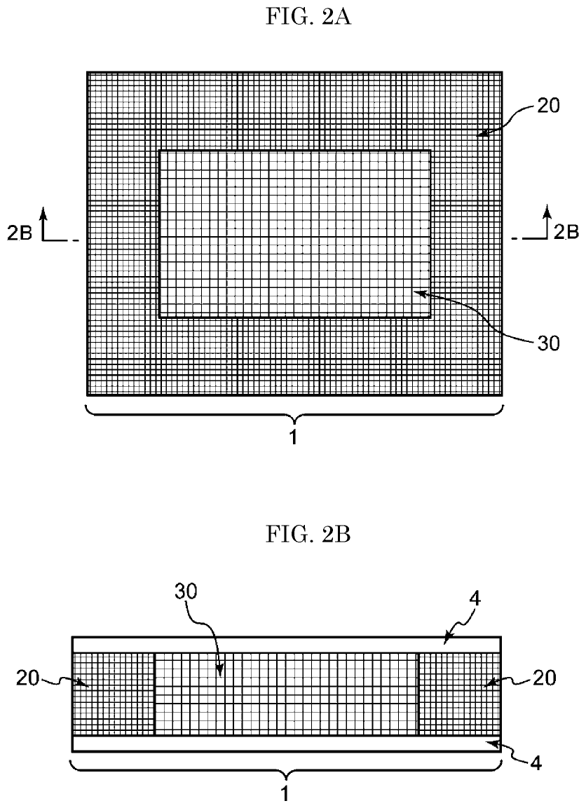

Magnetic sheet 1 that is one of main features of the exemplary embodiment will specifically be described below with reference to FIGS. 2A and 2B. The magnetic sheet used for the combined coil module is described in the exemplary embodiment. However, the magnetic sheet of the exemplary embodiment is not limited to the combined coil module, but can be used in wide variety of applications.

FIG. 2A is a schematic plan view illustrating the magnetic sheet used in the combined coil module of the exemplary embodiment, and FIG. 2B is a schematic sectional view (a schematic sectional view taken along a line 2B-2B in FIG. 2A) of the magnetic sheet.

Magnetic sheet 1 of the exemplary embodiment is constructed with one kind of a magnetic material constituting a magnetic path of the first planar coil and a magnetic path of the second planar coil.

As illustrated in FIG. 2A, magnetic sheet 1 includes first magnetic path formation portion (first portion) 20 in which the magnetic path of the first planar coil is formed and second magnetic path formation portion (second portion) 30 in which the magnetic path of the second planar coil is formed. In the exemplary embodiment, an arbitrary change of a frequency characteristic in one magnetic sheet made of the one kind of the magnetic material can satisfy both communication efficiency in the first planar coil and electric power transmission efficiency of the contactless charging in the second planar coil. For this reason, first magnetic path formation portion (first portion) 20 and second magnetic path formation portion (second portion) 30 are designed so as to vary in permeability.

As illustrated in FIG. 2B, magnetic sheet 1 constructed with first magnetic path formation portion 20 and second magnetic path formation portion 30 may include protective layer 4 on both the surfaces. For example, an ultraviolet curing type resin, a visible light curing type resin, a thermoplastic resin, a thermosetting resin, a heat-resistant resin, synthetic rubber, a double-sided tape, an adhesive layer, and a film can be used as protective layer 4. Protective layer 4 is not necessarily provided.

In magnetic sheet 1 made of the one kind of the magnetic material, as an example of means for arbitrarily changing the frequency characteristic using first magnetic path formation portion 20 and second magnetic path formation portion 30, as illustrated in FIGS. 2A and 2B, the magnetic sheet includes a slit or a dot. And a distance (roughness) between the slits or the dots of first magnetic path formation portion 20 is smaller than a distance (roughness) between the slits or the dots of second magnetic path formation portion 30. Magnetic sheet 1 having location dependency of the permeability can be obtained by changing the distance between the slits or the dots in first magnetic path formation portion 20 and second magnetic path formation portion 30. As used herein, the slit means a slit-shaped recess, and the dot means a dot-shaped recess. In the present disclosure, sometimes the slit-shaped recess and the dot-shaped recess are collectively referred to as a recess. The recess may have a hole shape piercing the magnetic sheet from the front surface to the rear surface.

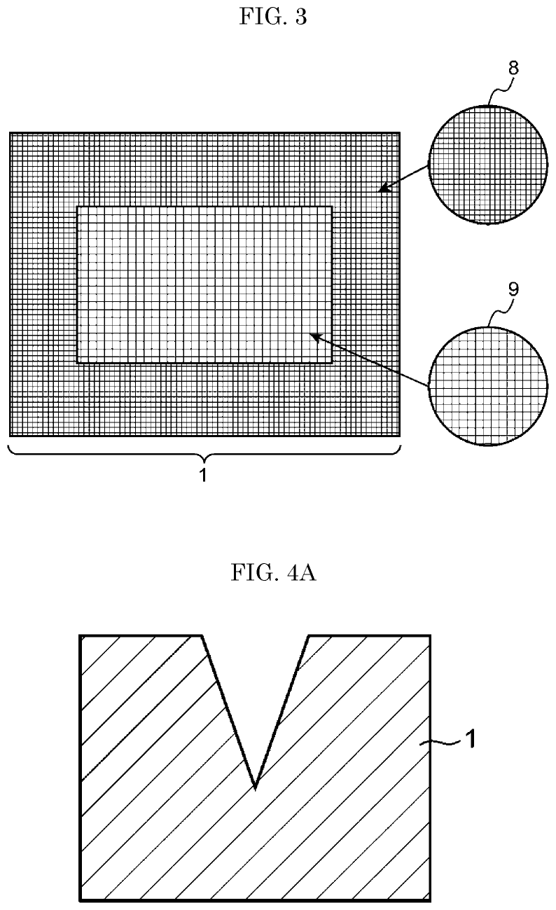

More specifically, for example, as illustrated in FIG. 3, in magnetic sheet 1 made of the one kind of the magnetic material, the slits are provided with a pitch ranging from 0 mm to 5 mm, inclusive, in first magnetic path formation portion (a portion placed on the NFC antenna portion) 8. And the slits are provided with a pitch of not less than 20 mm in second magnetic path formation portion (a portion placed on the contactless charging coil) 9. Hence, the magnetic sheet having different permeabilities from each other is obtained. At this point, magnetic sheet 1 of first magnetic path formation portion 8 has flexibility while magnetic sheet 1 of second magnetic path formation portion 9 has little flexibility. And the permeability can be changed in magnetic sheet 1 made of the one kind of the magnetic material. Although FIG. 3 illustrates an example of the slit, the dot can also be provided with a similar pitch. Preferably the distance between the adjacent slits or the adjacent dots that are formed in second magnetic path formation portion 9 is less than or equal to 100 mm.

As used herein, “pitch” means the distance between each two adjacent slits formed in longitudinal direction or lateral direction of main surface of the magnetic sheet. For example, the pitch is a value measured with an optical microscope or a laser shape measuring microscope. For specifically, for example, using VK-X150 (product of KEYENCE CORPORATION) as the laser shape measuring microscope, the magnetic sheet is set on the laser shape measuring microscope to adjust a magnification, which allows the measurement of an interval between the two adjacent slits formed on the magnetic sheet.

In magnetic sheet 1 of the exemplary embodiment, there is no limitation on an array shape as long as a constant interval (pitch) is provided between each two of the plurality of slits or the plurality of dots as described above. However, preferably the slits or the dots are uniformly provided in the whole surface of magnetic sheet 1. Preferably the slits or the dots are arrayed with given regularity such as a triangular pattern, a polygonal pattern, a geometrical pattern, and a lattice shape. This enables a break process (to be described later) to be uniformly performed.

More preferably the pitch of the slits or dots of first magnetic path formation portion 8 ranges from 0.05 mm to 5 mm, inclusive, and more preferably the pitch of the slits or dots of second magnetic path formation portion 9 ranges from 5 mm to 20 mm, inclusive.

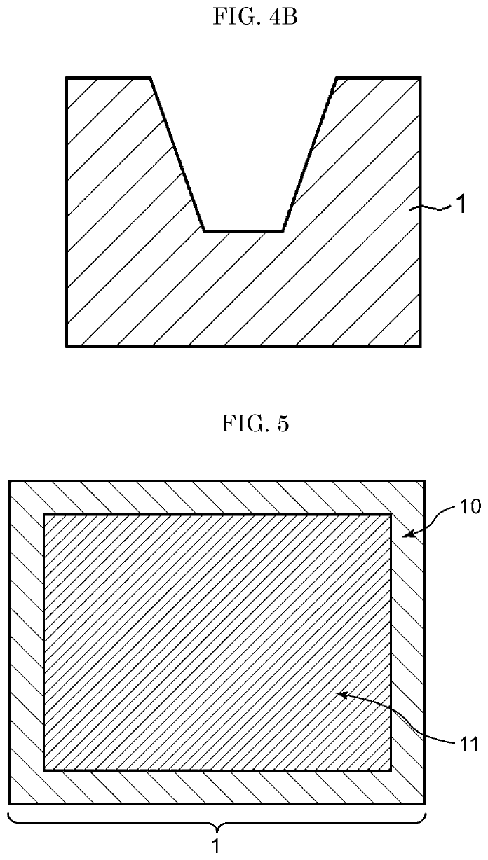

There is no particular limitation on the shape of the slit or the dot. For example, the slit or the dot may have a notch shape as illustrated in FIG. 4A or a through-hole. However, since generation of an undulation is prevented in a side of the thin magnetic material, preferably the slit or the dot is a recess having a bottom as illustrated in FIG. 4B.

There is not particular limitation on a depth of the slit or the dot in the exemplary embodiment. However, the depth ranges from 5% to 30%, inclusive, with respect to thickness d1 (about 100 μm) of the magnetic material (preferably the depth ranges from about 5 μm to about 30 μm). When the slit or the dot has the depth of the above range, the break process can easily be performed on the magnetic material, and the magnetic material can be formed flat.

Magnetic sheet 1 is divided into small pieces by the break process using the slit or the dot. In forming, although typically the slit or the dot is linearly formed, the slit or the dot may be formed into a folded or curved shape.

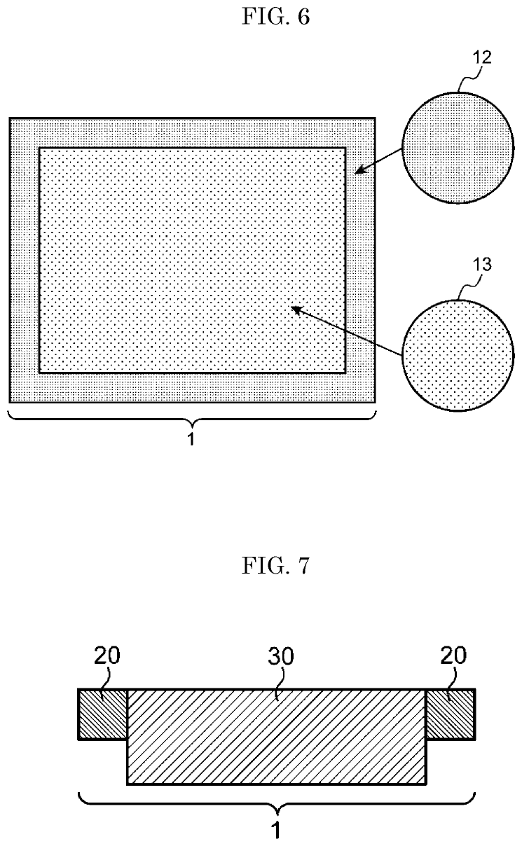

As another means for changing the permeability in magnetic sheet 1 made of the one kind of the magnetic material, as illustrated in FIG. 5, an elastic silicone resin is contained in first magnetic path formation portion 10, and an epoxy resin is contained in second magnetic path formation portion 11. Specifically, in the process of manufacturing magnetic sheet 1, the elastic silicone resin is applied to first magnetic path formation portion 10 on magnetic sheet 1 (elastic silicone applying portion), and the epoxy resin is applied to second magnetic path formation portion 11 (epoxy resin applying portion). And the break process is performed, which allows a difference of break states to be generated in the one magnetic sheet. For this reason, it is considered that the frequency characteristic of magnetic sheet 1 changes depending on the location where the different resin is applied and both the communication efficiency and the electric power transmission efficiency of the contactless charging in NFC can be satisfied in magnetic sheet 1 made of the one kind of the magnetic material.

There is no particular limitation on the elastic silicone resin used in the exemplary embodiment, and a commercially available elastic silicone resin can be used. TSE322-B (product of MOMENTIVE) can be cited as a preferable specific example of the elastic silicone resin. Similarly, there is no particular limitation on the epoxy resin, and 2206 (product of ThreeBond Co., Ltd.) can be cited as a preferable example of the epoxy resin.

As still another means, there is a method for setting a particle size of the magnetic material constituting the first magnetic path formation portion smaller than a particle size of the magnetic material constituting the second magnetic path formation portion.

Specifically, as illustrated in FIG. 6, for example, in magnetic sheet 1 made of the one kind of the magnetic material, the particle size of the magnetic material is set less than 5 mm in first magnetic path formation portion 12, and the particle size of the magnetic material is set greater than or equal to 5 mm in second magnetic path formation portion 13. Hence, the difference in the particle sizes of the magnetic material is generated in magnetic sheet 1 made of the one kind of the magnetic material. Therefore, permeability can be changed in magnetic sheet 1.

More preferably the particle size of the magnetic material ranges approximately from 0.05 mm to 5 mm, inclusive, in first magnetic path formation portion 12, and the particle size ranges approximately from 5 mm to 20 mm, inclusive, in second magnetic path formation portion.

In the exemplary embodiment, the particle size of the magnetic material means the small piece of the magnetic material generated through the break process, and means a value measured with an optical microscope or a laser shape measuring microscope. For specifically, for example, using VK-X150 (product of KEYENCE CORPORATION) as the laser shape measuring microscope, the magnetic material is set on the laser shape measuring microscope to adjust a magnification, which allows the measurement of a particle size formed on the magnetic material.

As yet another means, there is a method for decreasing the thickness of the magnetic sheet constituting the first magnetic path formation portion compared with the thickness of the magnetic sheet constituting the second magnetic path formation portion.

Specifically, as illustrated in FIG. 7, in magnetic sheet 1 made of the one kind of the magnetic material, the thickness of the magnetic sheet is set in the range from 50 μm to 200 μm, inclusive, in first magnetic path formation portion 20, and the thickness of the magnetic sheet is adjusted in the range from 200 μm to 500 μm, inclusive, in second magnetic path formation portion 30. Hence, the difference of the break states is generated in magnetic sheet 1 made of the one kind of the magnetic material, which allows the change in permeability of magnetic sheet 1.

There is no particular limitation on the method for adjusting the thickness of magnetic sheet 1, but a known method such as a method in which the thickness is decreased by cutting only first magnetic path formation portion 20 into the desired thickness may be adopted.

In addition, in magnetic sheet 1 made of the one kind of the magnetic material, the difference in the permeability can be generated between the portion placed on the NFC antenna and the portion placed on the contactless charging coil by setting a difference in burning temperatures between first magnetic path formation portion 20 and second magnetic path formation portion 30 in the manufacturing. Hence, both the communication efficiency and the electric power transmission efficiency of the contactless charging in NFC can be satisfied in magnetic sheet 1 made of the one kind of the magnetic material.

By using the methods described above, in magnetic sheet 1 made of the one kind of the magnetic material, the difference in the frequency characteristics between first magnetic path formation portion 20 and second magnetic path formation portion 30 can be generated. As a confirmation method, by using an RF impedance material analyzer, the permeability of the material is actually measured, or by measuring the particle size of the material with the laser shape measuring microscope, a determination can be made to some extent.

Magnetic sheet 1 of the exemplary embodiment may include a third portion having a permeability (third permeability) different from the permeability (first permeability) in first magnetic path formation portion (first portion) 20 and the permeability (second permeability) in second magnetic path formation portion (second portion) 30. Further, magnetic sheet 1 of the exemplary embodiment may include a third magnetic path formation portion (third portion) in which a magnetic path of a third planar coil is formed. The third magnetic path formation portion is different from first magnetic path formation portion (first portion) 20 in which the magnetic path of the first planar coil is formed and second magnetic path formation portion (second portion) 30 in which the magnetic path of the second planar coil is formed. That is, the third magnetic path formation portion (third portion) having the third permeability different from the permeability (first permeability) in first magnetic path formation portion (first portion) 20 and the permeability (second permeability) in second magnetic path formation portion (second portion) 30 can be designed by any method.

A configuration of the magnetic sheet of the exemplary embodiment will be described below.

The magnetic material used in the exemplary embodiment is a ferrite sintered body. Specifically, Mn(manganese)-Zn(zinc) based ferrite can be used, or magnetic materials such as Ni(nickel)-Zn(zinc) based ferrite, Mn(manganese)-Ni(nickel) based ferrite, and Mg(magnesium)-Zn(zinc) based ferrite can be used depending on the application. Magnetic materials such as amorphous metal, permalloy, magnetic steel, ferrosilicon, an Fe(iron)-Al(aluminum) alloy, and a Sendust alloy may be used. A magnetic material may be contained in a sheet-shape resin material.

The magnetic material of the exemplary embodiment is formed into the sheet shape, and preferably the thickness ranges approximately from 50 μm to 1000 μm, inclusive.

Protective layer 4 used for the combined coil module of the exemplary embodiment will be described below.

Preferably protective layer 4 used in the exemplary embodiment has an insulation property. For example, protective layer 4 is constructed with a flexible plastic film, such as polyethylene terephthalate (PET), which has a bonding layer. In the protective layer, the magnetic material divided into the small pieces is maintained into the sheet shape such that the small-piece magnetic material is not dropped or damaged. Both the surfaces of the magnetic sheet may be bonded to a PET film, or at least one of the surfaces is protected. Although the PET film is used in FIG. 1A, the protective layer may be formed by applying the elastic silicone resin and the epoxy resin as illustrated in FIG. 5. Alternatively, a silicone resin, a thermally active film, and an ultraviolet setting resin may be used. For example, the protective layer may be a bonding agent or a bonding sheet that bonds Flexible Printed Circuit (FPC) including an antenna pattern to a sheet-shaped magnetic material. The protective layer may be selected in consideration of not only the flexibility to bending or flexure of each unit constituting the combined coil module but also antiweatherability such as a heat-resistant property and a moisture-resistant property.

A method for manufacturing the magnetic sheet of the exemplary embodiment will be described below.

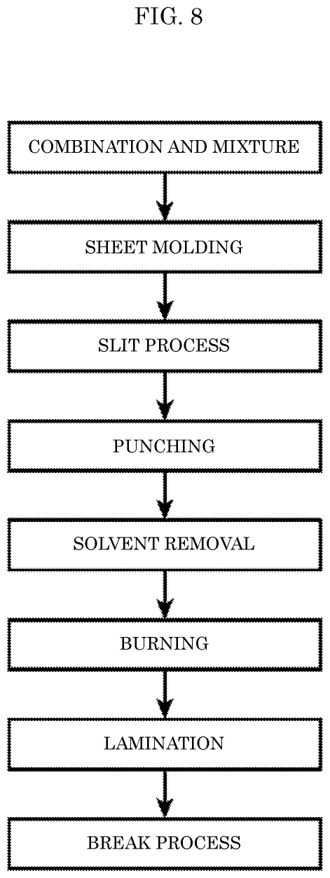

FIG. 8 is a flowchart illustrating the magnetic sheet manufacturing process of the exemplary embodiment. At this point, a ferrite sheet manufacturing flowchart will be described as an example of the magnetic sheet of the exemplary embodiment.

For example, as illustrated in the flowchart of FIG. 8, the magnetic sheet of the exemplary embodiment can be obtained through combination and mixture of material→sheet molding→slit process→punching→solvent removal→burning→lamination→break process. Each process will be described in detail.

In the combination and mixture of the material, ferrite powders and a polyvinyl butyral resin or a phthalate ester plasticizer and an organic solvent that become a binder are combined, and kneaded using a dedicated mill to prepare slurry. There is no particular limitation on viscosity of the prepared slurry as long as the slurry has proper viscosity as sheet molding use. For example, preferably the viscosity of the slurry ranges approximately from 1500 Pa·sec to 2500 Pa·sec, inclusive, at a temperature of 20° C.

In the sheet molding, the film of the prepared ferrite slurry is formed on a support such as the PET film using a doctor blade, and a thermal dry process is performed using a thermostatic chamber. Consequently, a green sheet having the thickness ranging from 50 μm to 350 μm, inclusive, is prepared. In the exemplary embodiment, the green sheet can also be molded using an extraction molding machine in addition to the doctor blade.

The plurality of slits or dots are formed in at least one of the surfaces of the prepared green sheet. Consequently, on the one magnetic sheet, the difference in the permeability of the magnetic material can be generated between the portion placed on the NFC antenna and the portion placed on the contactless charging coil. The slit process can be replaced with other above means for changing the permeability.

There is no particular limitation on the formation of the slit or the dot. For example, a roller in which a plurality of protrusions are regularly arrayed with a desired pitch is rotated while pressed against the green sheet, which allows the formation of the slit or the dot. Consequently, the plurality of protrusions enter the green sheet, and the plurality of slits or dots are formed on the green sheet.

The green sheet prepared by the above procedure is punched into a shape having a given size by a laser or a pinnacle. In the punched green sheet, the solvent that is the binder is removed with a temperature pattern under a predetermined condition (solvent removal). There is no particular limitation on the temperature of the solvent removal, and the temperature of the solvent removal can appropriately be set depending on a kind or a quantity of the organic solvent.

Subsequently, the burning is performed at a predetermined temperature in a burning furnace (burning). There is no particular limitation on the burning temperature, and the burning temperature can appropriately be set depending on a kind of the ferrite.

The PET film is stuck on both the surfaces of the burnt magnetic material using an automatic machine to form the protective layer.

Subsequently, the magnetic sheet in which the protective layer is formed on both the surfaces of the magnetic material by the PET film is press-welded from two directions of vertical and horizontal directions using a cylindrical rigid body (break process). The magnetic material existing in the protective layer is finely divided through this process, and the whole magnetic sheet becomes flexible.

The magnetic sheet of the exemplary embodiment can be produced through the processes.

As is well known, a relative permeability of the ferrite burned substance can be expressed using a complex permeability.

μ=μ′−jμ″

(μ: relative permeability, μ′: inductance component, μ″: resistance component)

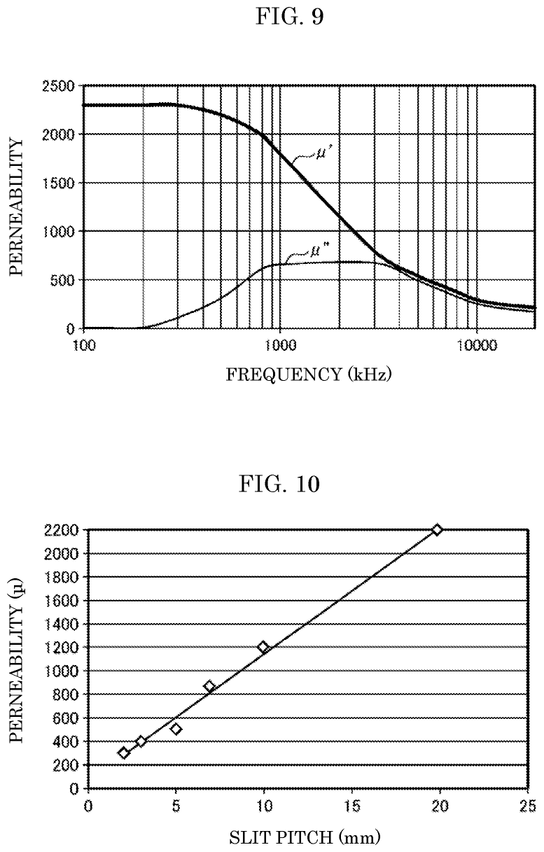

As illustrated in FIG. 9, although the permeability of the ferrite is kept constant up to a certain frequency, when the frequency is increased, a delay of a phase is generated, μ′ f (inductance component) is decreased, and μ″ (resistance component) is increased. This phenomenon is called a Snoelk's limit.

For this reason, the conventional Mn—Zn ferrite material can be used for the contactless charging because the conventional Mn—Zn ferrite material has the high permeability at a frequency of 100 kHz to 200 kHz and the high electric power transmission efficiency of the contactless charging. However, the conventional Mn—Zn ferrite material cannot be used at the 13.56-MHz band used for the NFC antenna because μ′ (inductance component) is decreased while μ″ (resistance component) is increased.

If the one kind of the ferrite material having the high permeability was used at the low frequency band to the high frequency band, the problem is solved. However, because of the phenomenon of the Snoelk's limit, actually it is necessary to properly use the ferrite materials according to the frequency band to be used. Thus, in the conventional combined coil module, it is necessary to use two kinds of different ferrite materials such that the Mn—Zn based ferrite is used for the contactless charging unit, and such that the Ni—Zn based ferrite is used for the NFC antenna.

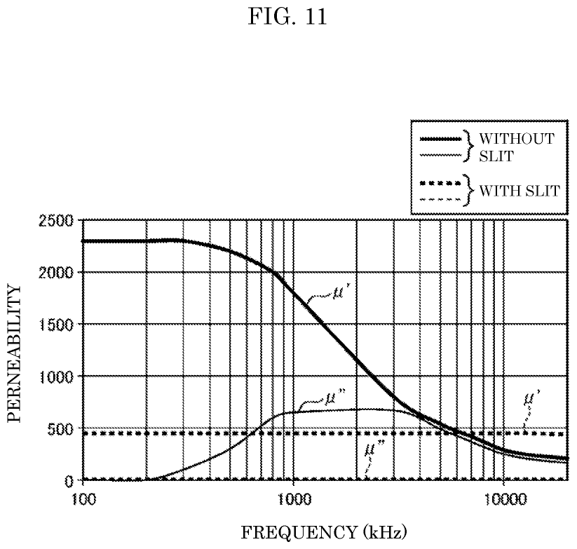

On the other hand, in the exemplary embodiment, the 80-μm-thickness magnetic sheet is formed using the Mn—Zn based ferrite material by the above manufacturing method, in which the slit having the depth of 10% to thickness d1 of the magnetic material is produced. And the permeability is measured while the slit pitch is changed, and the graph in FIG. 10 is obtained.

As can be seen from the graph in FIG. 10, μ′ (inductance component) and μ″ (resistance component) of the ferrite material can arbitrarily be changed by changing the slit pitch. Specifically, it is found that the permeability (μ) increases with increasing slit pitch.

When this phenomenon is applied, in the magnetic sheet made of the one kind of the magnetic material, the distance between each two of slits is changed by changing the slit pitch of the magnetic sheet in the portion placed on the NFC antenna from that in the portion placed on the contactless charging coil. And the inductance component and the resistance component of the permeability of the magnetic sheet made of the one kind of the magnetic material to be arbitrarily changed. Specifically, it is found that the permeability (μ) increases with increasing (roughening) slit pitch. As a result, as illustrated in FIG. 11, the magnetic sheet that sufficiently satisfies the characteristic in a 100-kHz band of the contactless charging and a 13.56-MHz band of the NFC antenna can be obtained.

Like the combined coil module of the exemplary embodiment, the modularization of the NFC antenna and the contactless charging coil using the magnetic sheet made of the one kind of the magnetic material can provide the miniaturization of the combined coil module and the simplification of the manufacturing process. And thus the cost reduction of the combined coil module can be achieved. Further, both the communication efficiency of the NFC and the electric power transmission efficiency of the contactless charging can be improved by the magnetic sheet made of the one kind of the magnetic material.

For example, the magnetic sheet of the exemplary embodiment can be used in various applications such as an antenna device, a cellular phone equipped with the contactless charging module, a digital camera, a mobile terminal such as a notebook PC, and a module of a contactless charging system of an electronic device.

The magnetic sheet of the exemplary embodiment can also be used in charging a battery of an electric automobile. Usually, in charging the battery of the electric automobile, charging performance is significantly damaged due to an eddy current generated by metal of a car body. However, the use of the magnetic sheet of the exemplary embodiment exerts an advantage that an adverse effect of an eddy current loss is prevented to provide desired charging performance.

### INDUSTRIAL APPLICABILITY

In the combined coil module of the present disclosure, the wound charging coil and the NFC antenna disposed so as to surround the charging coil are placed on the magnetic sheet made of the one kind of the magnetic material. By arbitrarily changing the frequency characteristic of the magnetic sheet made of the one kind of the magnetic material placed on the contactless charging coil and the NFC antenna, both the communication efficiency of the NFC and the electric power transmission efficiency of the contactless charging can be satisfied. The magnetic sheet of the present disclosure can be used for the combined coil module and the like. The modularization of the NFC antenna and the contactless charging coil using the magnetic sheet made of the one kind of the magnetic material can provide the miniaturization of the combined coil module and simplification of the manufacturing process, and cost reduction of the combined coil module can be achieved. Thus, the present disclosure is extremely useful for various electronic devices such as an antenna device including the NFC antenna and the contactless charging coil, a cellular phone, in particular, smartphone, a portable audio, a personal computer, a digital camera, and a video camera.

### REFERENCE MARKS IN THE DRAWINGS

1 magnetic sheet
2 first planar coil (NFC antenna)
3 second planar coil (contactless charging coil)
4 protective layer
5 substrate
6 bonding layer
8, 20 first magnetic path formation portion (first portion)
9, 30 second magnetic path formation portion (second portion)
10 first magnetic path formation portion (elastic silicone applying portion)
11 second magnetic path formation portion (epoxy resin applying portion)
12 first magnetic path formation portion (portion having small ferrite particle size)
13 second magnetic path formation portion (portion having large ferrite particle size)

1. A combined coil module comprising:
a first planar coil for radio communication;
a second planar coil for electric power transmission of contactless charging; and
a magnetic sheet in which a magnetic path of the first planar coil and a magnetic path of the second planar coil are to be formed, the magnetic sheet being made of one kind of a magnetic material, wherein:
the magnetic sheet includes a first magnetic path formation portion in which the magnetic path of the first planar coil is to be formed and a second magnetic path formation portion in which the magnetic path of the second planar coil is to be formed, and
a permeability of the first magnetic path formation portion is different from a permeability of the second magnetic path formation portion.

2. The combined coil module according to claim 1, wherein:
the magnetic sheet includes a plurality of recesses, and
a distance between each two of the plurality of recesses in the first magnetic path formation portion is smaller than a distance between each two of the plurality of recesses in the second magnetic path formation portion.

3. The combined coil module according to claim 2, wherein:
the distance between each two of the plurality of recesses in the first magnetic path formation portion ranges from 0 mm to 5 mm, inclusive, and
the distance between each two of the plurality of recesses in the second magnetic path formation portion is not less than 20 mm.

4. The combined coil module according to claim 1, wherein the first magnetic path formation portion is more flexible than the second magnetic path formation portion.

5. The combined coil module according to claim 1, wherein:
the first magnetic path formation portion contains an elastic silicone resin, and
the second magnetic path formation portion contains an epoxy resin.

6. The combined coil module according to claim 1, wherein a particle size of the magnetic material in the first magnetic path formation portion is smaller than a particle size of the magnetic material in the second magnetic path formation portion.

7. The combined coil module according to claim 1, wherein a thickness of the magnetic sheet in the first magnetic path formation portion is smaller than a thickness of the magnetic sheet in the second magnetic path formation portion.

8. The combined coil module according to claim 1, wherein the magnetic material is Mn—Zn based ferrite.

9. The combined coil module according to claim 2, wherein the plurality of recesses are a plurality of slit-shaped recesses or a plurality of dot-shaped recesses.

10. A magnetic sheet made of one kind of a magnetic material, the magnetic sheet comprising: a first portion having a first permeability; and a second portion having a second permeability, the second permeability being different from the first permeability.

11. The magnetic sheet according to claim 10, comprising a plurality of recesses, wherein a distance between each two of the plurality of recesses in the first portion is different from a distance between each two of the plurality of recesses in the second portion.

12. The magnetic sheet according to claim 11, wherein:
the distance between each two of the plurality of recess in the first portion ranges from 0 mm to 5 mm, inclusive, and
the distance between each two of the plurality of recess in the second portion is not less than 20 mm.

13. The magnetic sheet according to claim 10, wherein the first portion is more flexible than the second portion.

14. The magnetic sheet according to claim 10, wherein:
the first portion contains an elastic silicone resin, and
the second portion contains an epoxy resin.

15. The magnetic sheet according to claim 10, wherein a particle size of the magnetic material in the first portion is smaller than a particle size of the magnetic material in the second portion.

16. The magnetic sheet according to claim 10, wherein a thickness of the magnetic sheet in the first portion is smaller than a thickness of the magnetic sheet in the second portion.

17. The magnetic sheet according to claim 10, wherein the magnetic material is Mn—Zn based ferrite.

18. The magnetic sheet according to claim 10, further comprising a third portion having a third permeability, the third permeability being different from the first permeability and the second permeability.

19. The magnetic sheet according to claim 11, wherein the plurality of recesses are a plurality of slit-shaped recesses or a plurality of dot-shaped recesses.
